(19) United States
(12) Patent Application Publication
(10) Pub. No.: US 2024/0153677 A1
(43) Pub. Date: May 9, 2024

(54) GROMMET UNIT AND WIRE HARNESS

(71) Applicant: SUMITOMO WIRING SYSTEMS, LTD., Mie (JP)

(72) Inventor: Takuya MURATA, Mie (JP)

(21) Appl. No.: 18/281,399

(22) PCT Filed: Mar. 11, 2022
(86) PCT No.: PCT/JP2022/010772

§ 371 Date: Sep. 11, 2023

(30) Foreign Application Priority Data
Mar. 15, 2021 (JP) 2021-041309

(51) Int. Cl. H01B 17/58; B60R 16/02; H01R 13/52

(52) U.S. Cl. CPC H01B 17/583; B60R 16/0222; H01R 13/5213; H02G 3/22

(57) ABSTRACT

A grommet unit includes a grommet that partially covers a connector and a wiring member mounted in a vehicle, and a barrier member that is molded separately from the grommet. The grommet has a main body part that covers the connector 20 and the wiring member and a tubular drain part that is continuous with the main body part and drains water inside the main body part. The main body part has a connection port that is open in a first direction and into which a connection part of the connector is inserted. The tubular drain part extends in a second direction that intersects the first direction. The barrier member is attached to the inside of the tubular drain part and partially blocks a drain path in the tubular drain part.

### TECHNICAL FIELD

The present disclosure relates to a grommet unit and a wire harness.

### BACKGROUND

Patent Document 1 discloses a wire harness that is provided in a vehicle in which an internally mounted power storage device is charged using an external power source. A grommet that covers a cable coupled to an inlet is provided on the rear surface side of an inlet base. The grommet is provided with a collective drain member that drains water from the grommet.

### PRIOR ART DOCUMENT

### Patent Document

Patent Document 1: JP 2011-175764 A

### SUMMARY OF THE INVENTION

### Problems to be Solved

In the grommet described in Patent Document 1, sand, dirt, and the like (hereinafter, referred to as dust and the like) may enter the grommet through the collective drain member. In order to reduce the influence of dust and the like that has entered the grommet, the structure of the grommet or a connector may be made more complex.

An object of the present disclosure is to provide a technique that makes it possible to suppress the entrance of dust and the like from a tubular drain part while suppressing an increase in the structural complexity of a grommet and a connector.

### Means to Solve the Problem

A grommet unit of the present disclosure is a grommet unit that includes a grommet that partially covers a connector and a wiring member mounted in a vehicle; and a barrier member that is molded separately from the grommet, wherein the grommet has a main body part that covers the connector and the wiring member and a tubular drain part that is continuous with the main body part and drains water inside the main body part, the main body part has a connection port that is open in a first direction and into which a connection part of the connector is inserted, the tubular drain part extends in a second direction that intersects the first direction, and the barrier member is attached to the inside of the tubular drain part and partially blocks a drain path in the tubular drain part.

### Effect of the Invention

According to the present disclosure, it is possible to suppress the entrance of dust and the like from a tubular drain part while suppressing an increase in the structural complexity of a grommet and a connector.

### BRIEF DESCRIPTION OF THE DRAWINGS

FIG. 1 is a perspective view of a grommet unit and a wire harness including the grommet unit according to a first embodiment.

FIG. 2 is a bottom view of the grommet unit and the wire harness including the grommet unit according to the first embodiment.

FIG. 3 is a cross-sectional view taken along line in FIG. 2.

FIG. 4 is an enlarged view of an area A in FIG. 3.

FIG. 5 is a rear view of an inlet and a wiring member.

FIG. 6 is a front view of the inlet.

FIG. 7 is a perspective view of a grommet.

FIG. 8 is a perspective view of a barrier member.

FIG. 9 is a side view showing one side of the barrier member.

FIG. 10 is a side view showing another side of the barrier member.

### DETAILED DESCRIPTION TO EXECUTE THE INVENTION

### Description of Embodiments of Present Disclosure

First, embodiments of the present disclosure will be listed and described.

A grommet unit of the present disclosure is as described below.

(1) A grommet unit of the present disclosure is a grommet unit that includes a grommet that partially covers a connector and a wiring member mounted in a vehicle; and a barrier member that is molded separately from the grommet, wherein the grommet has a main body part that covers the connector and the wiring member and a tubular drain part that is continuous with the main body part and drains water inside the main body part, the main body part has a connection port that is open in a first direction and into which a connection part of the connector is inserted, the tubular drain part extends in a second direction that intersects the first direction, and the barrier member is attached to the inside of the tubular drain part and partially blocks a drain path in the tubular drain part. When the barrier member partially blocks the drain path in the tubular drain part, the drain path can make dust and the like outside of the grommet unlikely to enter the grommet while enabling drainage of water inside the grommet in the drain path. Since the barrier member is a member that is molded separately from the grommet and the connector, it is not essential to change the structures of the grommet and the connector. This makes it possible to suppress the entrance of dust and the like from the tubular drain part while suppressing an increase in the structural complexity of the grommet and the connector.

(2) In the grommet unit according to (1), the barrier member may have at least one side wall that extends along an inner surface of the tubular drain part and at least one partition that protrudes from an inner surface of the side wall. Accordingly, it is easy to block the drain path in the tubular drain part so as to enable drainage of water from inside the grommet and make dust and the like outside of the grommet unlikely to enter the grommet. The presence of the side wall makes it easy to keep the partition in a posture appropriate for the tubular drain part.

(3) In the grommet unit according to (2), the barrier member may have a plurality of the partitions, the plurality of partitions may be separated from each other in the second direction, a region where the drain path is blocked may be different at a plurality of positions where the plurality of partitions are provided, and the drain path may be fully blocked by the barrier member when observed from the second direction. Since the drain path is fully blocked by the barrier member when observed from the second direction, even if dust and the like attempt to intrude straight into the tubular drain part along the second direction, the dust and the like collide with the barrier member. This makes the dust and the like unlikely to reach the inside of the grommet through the tubular drain part. Since the plurality of partitions are separated from each other in the second direction, it is easy to keep the water in the grommet in a state where it can be drained to outside of the grommet through the partitions.

(4) In the grommet according to (2) or (3), the barrier member may have four side walls that are provided so as to form a rectangular shape when observed from the second direction, and the partitions may respectively protrude from the four side walls. Accordingly, the pathway for dust and the like to reach the inside of the grommet through the tubular drain part becomes more complex so that the dust and the like are unlikely to reach the inside of the grommet through the tubular drain part.

(5) In the grommet unit according to (4), the four partitions may be provided in a spiral manner. Accordingly, in order for dust and the like to pass through the barrier member, the dust and the like need to move in a spiral manner from one side to the other side along the second direction. This makes the dust and the like unlikely to pass through the barrier member.

(6) In the grommet unit according to any one of (2) to (5), the barrier member may have a protrusion that is provided on an outer surface of the side wall and is caught on an inner surface of the tubular drain part. This makes the barrier member unlikely to be dislodged from the tubular drain part.

(7) In the grommet unit according to any one of (2) to (6), the barrier member may be an injection-molded article that is molded by using metal molds, a side wall with a recessed part for separating the metal molds in a vertical direction may be provided as the side wall, and the barrier member may be formed in a shape in which no undercut is formed along a normal direction of the side wall with the recessed part. Accordingly, when the barrier member is injection-molded, the metal molds can be vertically removed along the normal direction of the side wall with the recessed part, which suppresses an increase in the number of metal molds.

(8) In the grommet unit according to any one of (1) to (7), the main body part may be provided with a grommet-side partition that overlaps the tubular drain part when viewed from the second direction, and the grommet-side partition may be disposed inside the main body part between a space in which the wiring member is disposed and a connection part between the tubular drain part and the main body part. Accordingly, even if dust and the like enter the grommet from the tubular drain part, the grommet-side partition suppresses the dust and the like from reaching the space in which the wiring member is disposed.

(9) In the grommet unit according to any one of (1) to (8), the main body part may have a pullout port that is open in a third direction intersecting the first direction and the second direction and through which the wiring member is passed to outside of the grommet. Accordingly, it is possible to decrease the height of a part of the grommet attached to the connector as compared to the case where the wiring member extends from the grommet in the first direction.

(10) A wire harness of the present disclosure is a wire harness that includes a connector, a wiring member that extends from the connector, and the grommet unit according to any one of (1) to (9), wherein the grommet partially covers the connector and the wiring member. When the barrier member partially blocks the drain path in the tubular drain part, it is possible to suppress the entrance of dust and the like from the tubular drain part. Since the barrier member is a member separate from the grommet and the connector, it is not essential to change the structure of the grommet and the connector. This suppresses the intrusion of dust and the like from the tubular drain part while suppressing an increase in the structural complexity of the grommet and the connector.

### Details of Embodiments of Present Disclosure

Specific examples of a grommet unit and a wire harness of the present disclosure will be described below with reference to the drawings. It should be noted that the present disclosure is not limited to the examples herein, but rather is indicated by the claims, and is intended to include all modifications within a meaning and scope equivalent to the claims.

### First Example

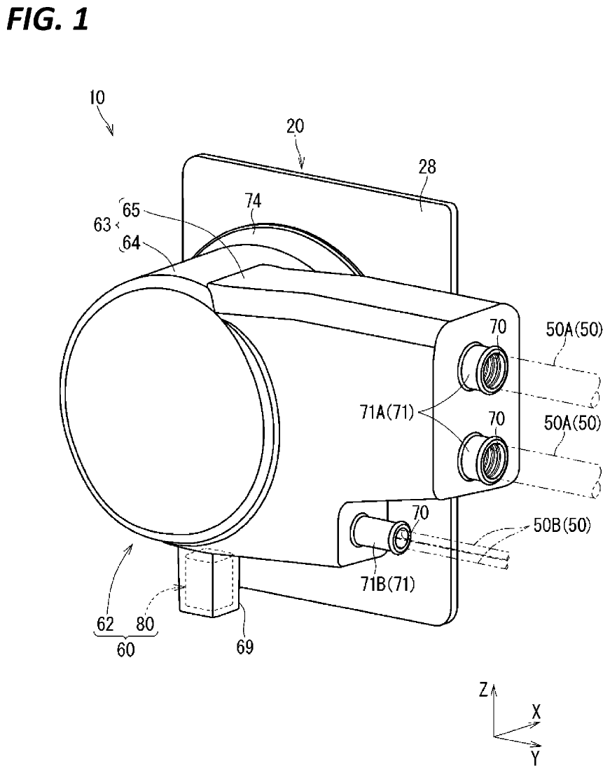

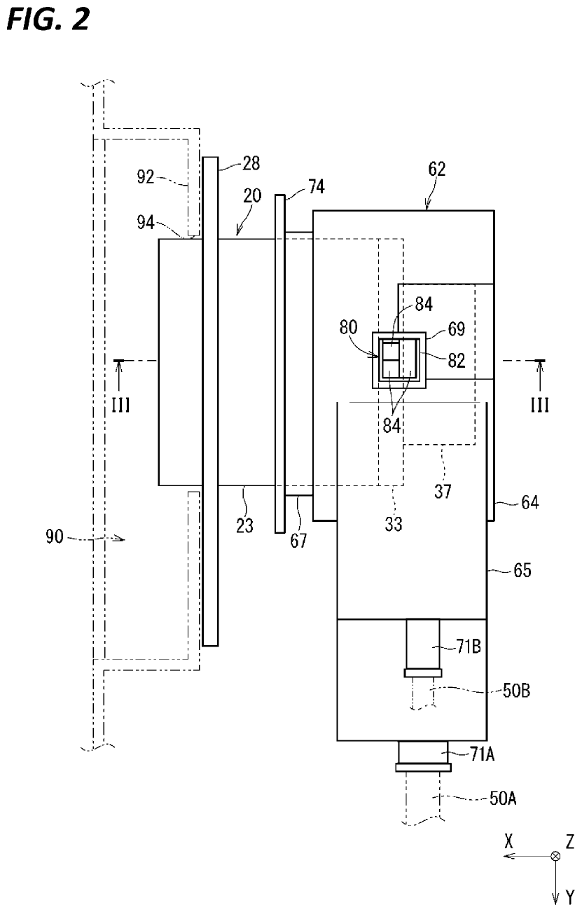

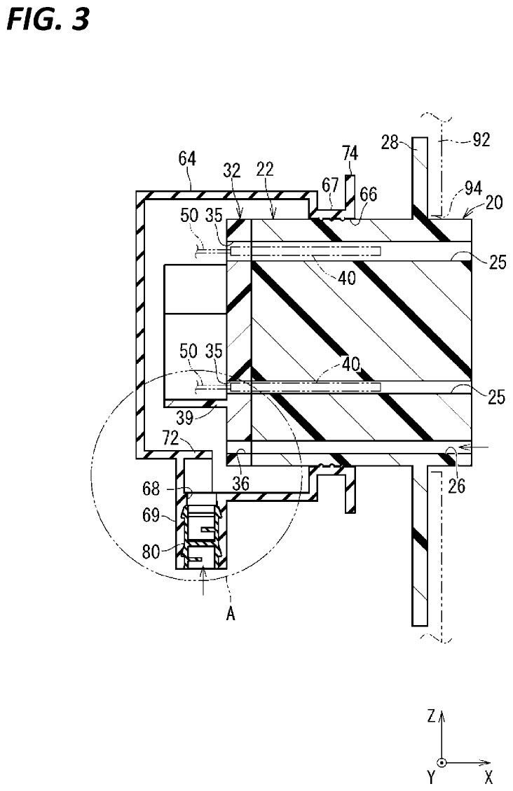

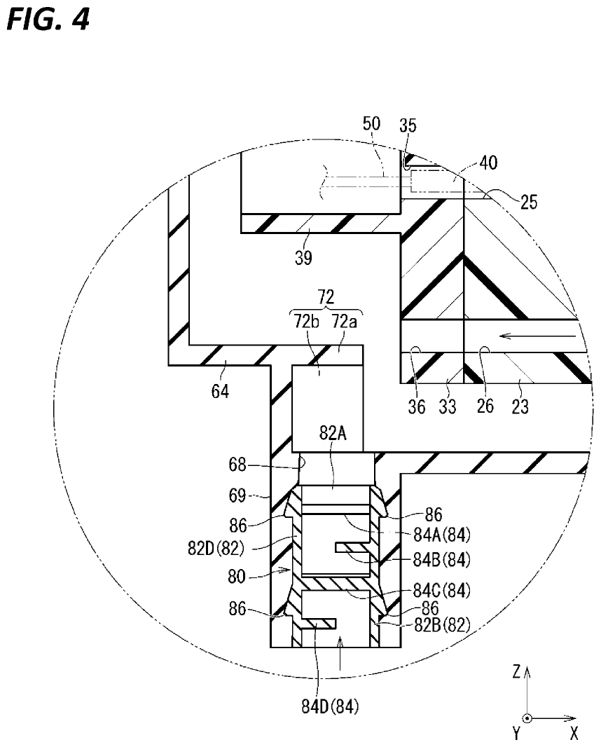

Hereinafter, a grommet unit and a wire harness including the grommet unit according to a first embodiment will be described. FIG. 1 is a perspective view of a grommet unit 60 and a wire harness 10 including the grommet unit 60 according to the first embodiment. FIG. 2 is a bottom view of the grommet unit 60 and the wire harness 10 including the grommet unit 60 according to the first embodiment. FIG. 3 is a cross-sectional view taken along line in FIG. 2. FIG. 4 is an enlarged view of an area Ain FIG. 3.

<Wire Harness>

The wire harness 10 includes a connector 20, a wiring member 50, and the grommet unit 60. The connector 20 has a connection part that is connected to a counterpart connector. The wiring member 50 is connected to a terminal 40 of the connector 20 and extends outward from the connector 20. The grommet unit 60 includes a grommet 62 and a barrier member 80. The grommet 62 partially covers the connector 20 and the wiring member 50. The barrier member 80 is attached to the grommet 62. In this example, an example is described where the connector 20 is an inlet 20. The connector 20 is not required to be the inlet 20 and may be any connector mounted in a vehicle.

The wire harness 10 including the inlet 20 is incorporated into a vehicle. The vehicle is an electric-powered vehicle that includes a power storage device and a motor. The vehicle travels by driving the motor with power from the power storage device. The vehicle may be an electric automobile that includes only a motor serving as a drive source or may be a hybrid vehicle that includes a motor and an engine. The power storage device in the vehicle is charged with power supplied from an external charging stand. The inlet 20 of the wire harness 10 is attached to an inlet attachment part 90 that is provided on the outer surface of the body of the vehicle, for example. FIG. 2 shows an example of the inlet attachment part 90. The inlet attachment part 90 has a recessed shape in which a part of a panel 92 constituting the body is recessed toward the inside of the vehicle, for example. The panel 92 forming the bottom part of the inlet attachment part 90 has a through hole 94. A part of the wire harness 10 is disposed on the inner side of the vehicle relative to the panel 92, and the other part of the wire harness 10 extends through the through hole 94.

The inlet 20 is configured such that an external charging connector can be inserted and electrically connected thereto. The external charging connector is a connector of a charging cable that extends from a charging stand, for example. The front side of the inlet 20 is provided with a connection part to which the external charging connector is connected. The connection part includes a part into which the external charging connector is inserted and electrically connected. A portion of the connection part extends through the through hole 94 of the panel 92. The housing of the inlet 20 and the front-side portion of the terminal 40 are used as the connection part. The wiring member 50 extends from the inlet 20. The wiring member 50 transmits power from the charging stand to the power storage device of the vehicle. The grommet 62 protects the inlet 20 and the wiring member 50 and stops water from entering the inlet 20, in the inner space of the vehicle relative to the panel 92. The grommet 62 has a connection port 66, a drain port 68, and pullout ports 70. The connection part of the inlet 20 extends to the outside of the grommet 62 through the connection port 66. Water in the grommet 62 is drained to the outside of the grommet 62 through the drain port 68. The wiring member 50 extends to the outside of the grommet 62 through the pullout ports 70.

In the present disclosure, as shown in FIG. 2, out of the X, Y, and Z directions orthogonal to one another, the X direction is a direction parallel to the direction in which the inlet 20 extends through the through hole 94 of the panel 92. The inlet 20 and the external charging connector are connected to each other in the X direction. The Z direction is a vertical direction, for example. If the inlet 20 is provided on a side surface of the vehicle, for example, the Y direction is the front-back direction of the vehicle. If the inlet 20 is provided on the front surface or the back surface of the vehicle, for example, the Y direction is the width direction of the vehicle. In the grommet 62, the connection port 66 is open in the X direction, the pullout ports 70 are open in the Y direction, and the drain port 68 is open in the Z direction. Unattached members will also be described using directions corresponding to the X direction, the Y direction, and the Z direction applied to the attached members.

<Inlet and Wiring Member>

Here, the inlet 20 has the connection part described above and a fixing part 28. The fixing part 28 is a part that is used to fix the inlet 20 to the vehicle. The connection part and the fixing part 28 of the inlet 20 are formed by combining a plurality of components. The inlet 20 includes, as the plurality of components, a first member 22, a second member 32, and the terminal 40.

The first member 22 has a first housing part 23. The first housing part 23 extends through the through hole 94. The outer shape of the first housing part 23 preferably corresponds to the shape of the through hole 94. Here, the outer shape of the first housing part 23 and the shape of the through hole 94 are circular. The first housing part 23 has first cavities 25 and a first water-escape hole 26 that extend through the first housing part 23 in the X direction.

The second member 32 has a second housing part 33. The second housing part 33 has second cavities 35 and a second water-escape hole 36 that pass through the second housing part 33 in the X direction. The first housing part 23 and the second housing part 33 are coupled together in the X direction. The second housing part 33 is positioned on the inner side of the vehicle relative to the first housing part 23 along the X direction. The first cavities 25 and the second cavities 35 are in communication with each other in the X direction to form one cavity, respectively. The terminal 40 is housed in these cavities to form the connection part.

One end portion of the terminal 40 is electrically connected to the terminal of an external charging connector when the external charging connector is inserted into the inlet 20. The other end portion of the terminal 40 is electrically connected to the wiring member 50. In the inlet 20, the terminal 40 and the wiring member 50 are kept in the connected state. The mode of connection between the terminal 40 and the wiring member 50 is not particularly limited and may be crimping, welding, or the like. Here, as the terminal 40, two terminals 40A used for power lines and two terminals 40B used for signal lines are provided. As a matter of course, the number and application of the terminal(s) 40 are not limited to this. The number and application of the terminal(s) 40 can be set as appropriate in accordance with the number and application of the terminal(s) of the external charging connector.

The first water-escape hole 26 and the second water-escape hole 36 are in communication with each other in the X direction and form one water-escape hole. The water-escape hole suppresses the accumulation of water in a space of the inlet attachment part 90 outside of the panel 92. Water accumulated in the space of the inlet attachment part 90 outside of the panel 92 is guided into a space on the inner side of the panel 92 through the water-escape hole. Here, water is guided into the grommet 62 through the water-escape hole. Water that has been guided to the inside of the grommet 62 is discharged to the outside of the grommet 62 through the drain port 68 in the grommet 62.

The first member 22 also has the fixing part 28. The fixing part 28 protrudes in a flange shape from the outer surface of the first housing part 23 (here, the outer surface of the portion positioned on the inner side of the vehicle relative to the panel 92). The fixing part 28 is made larger than the through hole 94 of the panel 92. The mode of fixing between the fixing part 28 and the panel 92 is not particularly limited, and the fixing part 28 and the panel 92 may be fixed to each other as described below, for example. That is, the fixing part 28 has a fixing hole. The panel 92 has a stud bolt on the inner surface of the peripheral edge portion of the through hole 94. The stud bolt is fastened to the fixing hole to fix the fixing part 28 and the panel 92 to each other. Accordingly, the inlet 20 is attached to the inlet attachment part 90.

The second member 32 also has a housing-side partition 37. The housing-side partition 37 has a plate shape and extends in the X direction from the back end surface of the second housing part 33. The housing-side partition 37 has a leading end portion that is open along the X direction. The housing-side partition 37 includes two first partitions 38 that partition the terminals 40A. The housing-side partition 37 also includes a second partition 39 that partitions the opening of the water-escape hole and the openings of the cavities. The first partitions 38 each have an opening at a portion thereof in a YZ plane. Portions of wiring members 50A closer to the other end side than the portions connected to the terminals 40A are pulled out from the openings. Here, the openings of the first partitions 38 are open upward along the Z direction. However, the openings of the two first partitions 38 may be open in mutually different directions. The second partition 39 is connected to one first partition 38, and thus is closed on one side in the Y direction (here, the negative side in the Y direction). The second partition 39 is not connected to the other first partition 38 and is open on the other side in the Y direction (here, the positive side in the Y direction). Here, the orientation of the opening of the second partition 39 in the Y direction and the pull-out direction of the wiring member 50 are the same but may be opposite.

The first member 22 is an integrally molded article in which the first housing part 23 and the fixing part 28 are integrally formed. The second member 32 is an integrally molded article in which the second housing part 33 and the housing-side partition 37 are integrally formed. The first member 22 and the second member 32 are made of insulating materials such as resin. The first member 22 and the second member 32 may be made of a material such as resin and integrally formed using a metal mold.

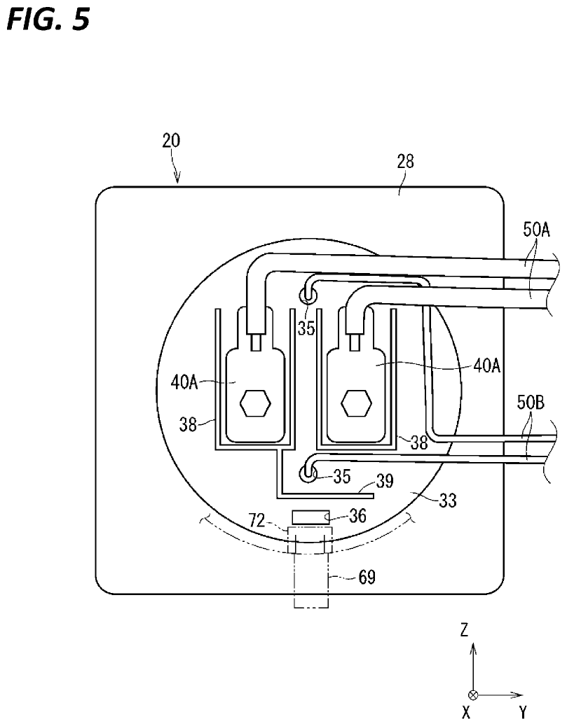

In the present example, as the wiring member 50, a plurality of (two in the example shown in FIG. 5) wiring members 50A used as power lines and a plurality of (two in the example shown in FIG. 5) wiring members SOB used as signal lines are provided. The wiring members 50A forming power lines are thicker than the wiring members SOB forming signal lines. Thus, the wiring members 50A forming power lines are less likely to bend than the wiring members SOB forming signal lines. Each of the four wiring members 50 is a single coated electrical wire that has a conductor and a coating layer. The four wiring members 50 extend from the outside to the inside of the grommet 62. One end portion of each wiring member 50A forming a power line is connected to the corresponding terminal 40A. One end portion of each wiring member 50B forming a signal line is connected to the corresponding terminal 40B. The other end portions of the four wiring members 50 extend to the outside of the grommet 62 and are connected to their respective connection counterparts. The connection counterparts are designed in accordance with the specifications of the charging system of the vehicle, and may be power storage devices, AC-DC converters, DC-DC converters, or electrical control units (ECUs), for example.

As a matter of course, the number and application of the wiring members 50 are not limited to this and can be set as appropriate in accordance with the specifications of the charging system of the vehicle. For example, the wiring members 50 may be composite cables in which a plurality of single wires are covered by one sheath, and the composite cables may extend from the outside to the inside of the grommet 62. For example, some of the wiring members 50 in the wire harness 10 may not be connected to external charging connectors. Such wiring members 50 may be connected to electrical components such as sensors that are incorporated in the inlet 20, for example.

<Grommet>

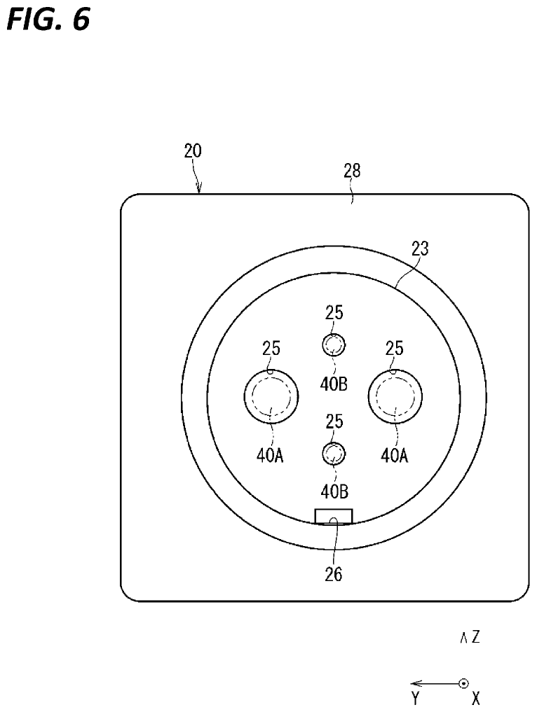

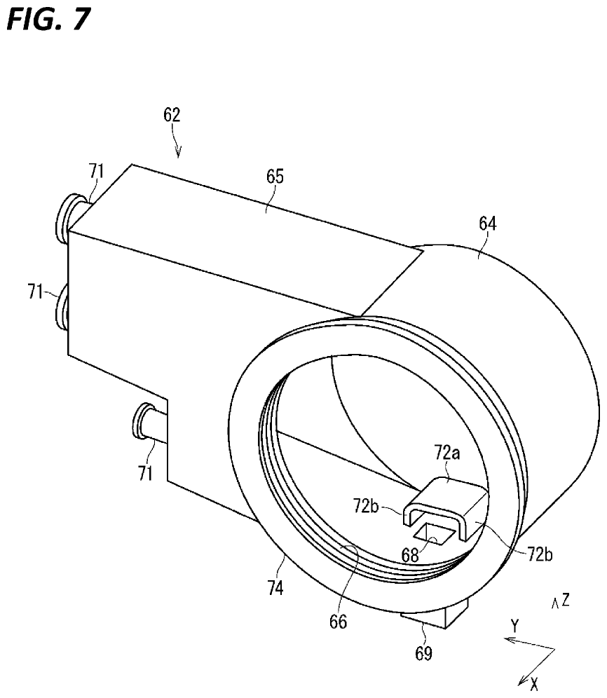

The grommet 62 in the grommet unit 60 will be described with reference to FIG. 7 in addition to FIGS. 1 to 6. FIG. 7 is a perspective view of the grommet 62.

The grommet 62 includes a main body part 63 and a flange part 74. The grommet 62 is an integrally molded article in which the main body part 63 and the flange part 74 are integrally formed. The grommet 62 is made of an elastic material. The material of the grommet 62 may be an elastomer such as ethylene propylene diene monomer (EPDM) rubber that is highly elastic, for example The grommet 62 may be made of an elastic material and integrally formed using a metal mold as described above.

The main body part 63 partially covers the inlet 20 and the wiring members 50. The main body part 63 has the connection port 66, the drain port 68, and the pullout ports 70. The connection port 66 is larger than the drain port 68 and the pullout ports 70. The drain port 68 has a tubular drain part 69 that is formed in a tubular shape. The barrier member 80 is attached to the inside of the tubular drain part 69.

In the present disclosure, the direction in which the connection port 66 is open is a first direction. The first direction is parallel to the X direction. The direction in which the drain port 68 is open is a second direction, and the direction in which the pullout ports 70 are open is a third direction. As stated above, the pullout ports 70 are open in the Y direction, and the drain port 68 is open in the Z direction. Thus, here, the first direction, the second direction, and the third direction are orthogonal to one another. However, the first direction, the second direction, and the third direction do not necessarily need to be orthogonal to one another. For example, the second direction may be a direction that intersects the X direction, the Y direction, and the Z direction.

In the present example, the main body part 63 has a first part 64 and a second part 65. In the present example, as the drain port 68 is provided with the tubular drain part 69, the connection port 66 and the pullout ports 70 are provided with a cylindrical connection part 67 and cylindrical pullout parts 71 that are formed in a tubular shape, respectively.

The first part 64 is a part that mainly covers the connection part of the inlet 20. The second part 65 is a part that mainly covers a portion of the wiring members 50 that is closer to the other end side relative the parts connected to the terminals 40, and extends in the second direction. The first part 64 and the second part 65 are both hollow, and the internal space of the first member 22 and the internal space of the second member 32 are connected to each other. It is sufficient that the first part 64 is shaped so as to cover the connection part of the inlet 20, and is preferably shaped in accordance with the connection part of the inlet 20. It is sufficient that the second part 65 is shaped so as to cover a portion of the wiring member 50 extending in the second direction. The internal space of the second part 65 is larger than the entire outer shape of the plurality of wiring members 50. The second part 65 can house the plurality of wiring members 50 without the wiring members 50 being in close contact with each other. Here, the first part 64 has a circular cross section shaped so as to be continuous in the first direction, and the second part 65 has an angular cross section (here, a square cross section) shaped so as to be continuous in the second direction.

The connection port 66 is provided at one end portion of the first part 64 along the X direction. No opening is formed at the other end portion of the first part 64 along the X direction (the end portion opposite to the end portion provided with the connection port 66). The drain port 68 is provided at a portion of the first part 64 that is an intermediate portion along the X direction and is the lowest portion along the Z direction. The second part 65 is provided at a portion of the first part 64 that is different from the portion provided with the drain port 68. The second part 65 extends in the Y direction from the portion where it is connected to the first part 64. The pullout ports 70 are provided at a leading end portion of the second part 65 along the Y direction. However, the second part 65 may not be provided in the main body part 63. The pullout ports 70 may be provided in the first part 64.

The cylindrical connection part 67 has a uniform cross section formed in a tubular shape so as to be continuous in the X direction. The cylindrical connection part 67 lengthens the connection port 66 in the X direction. The cylindrical connection part 67 may have a lip portion on the inner surface thereof, for example. The lip portion is annularly shaped so as to be contactable with the outer surface of the connection part (here, the outer surface of the first housing part 23). When the lip portion is pressed against the outer surface of the connection part, the flow of water is stopped between the inlet 20 and the grommet 62 at the connection port 66.

The tubular drain part 69 has a uniform cross section formed in a tubular shape so as to be continuous in the Z direction. The tubular drain part 69 lengthens the drain port 68 in the Z direction. Here, the lateral cross sections of the drain port 68 and the tubular drain part 69 are rectangular in shape. The lateral cross sections of the drain port 68 and the tubular drain part 69 may be circular or the like in shape.

The cylindrical pullout parts 71 each have a uniform cross section formed in a tubular shape so as to be continuous in the Y direction. The cylindrical pullout parts 71 lengthen the pullout ports 70 in the Y direction. The cylindrical pullout parts 71 may each have a lip portion on the inner surface thereof. The lip portion is annularly shaped so as to be contactable with the wiring member 50. When the lip portion is pressed against the outer surface of the wiring member 50, the flow of water is stopped between the wiring member 50 and the grommet 62 at the pullout port 70.

In the present example, a plurality of (three in the example shown in FIG. 1) cylindrical pullout parts 71 (the pullout ports 70) are formed. The two wiring members 50A are separately inserted into two cylindrical pullout parts 71A of the three cylindrical pullout parts 71. The two wiring members 50B are collectively inserted into one cylindrical pullout part 71B of the three cylindrical pullout parts 71. Since the wiring members 50A are less likely to bend than the wiring members 50B, the cylindrical pullout parts 71A are preferably provided at positions where the wiring members 50A are bent as little as possible. Here, the wiring members 50A extend upward along the third direction from the parts connected to the terminals 40A. Thus, the two cylindrical pullout parts 71A are positioned above the cylindrical pullout part 71B.

The main body part 63 has a grommet-side partition 72. The grommet-side partition 72 overlaps the drain port 68 when viewed from the Z direction. The grommet-side partition 72 is disposed in the main body part 63 between a space where the wiring member 50 is disposed and a connection part between the tubular drain part 69 and the main body part 63. Here, the second partition 39 partitions the space where the wiring member 50 is disposed and the space where the drain port 68 is present. The grommet-side partition 72 is disposed between the second partition 39 and the drain port 68 along the Z direction. The grommet-side partition 72 protrudes along the X direction from the inner surface of the end portion of the first part 64 on the side opposite to the connection port 66. The grommet-side partition 72 has a partition main body 72a and a pair of leg parts 72b. The partition main body 72a is a part that overlaps the drain port 68 when viewed from the Z direction. The partition main body 72a is spaced apart from the drain port 68 along the Z direction. The pair of leg parts 72b are parts that connect the partition main body 72a and a portion of the main body part 63 around the drain port 68 to each other. The pair of leg parts 72b are separated from each other along the Y direction. The drain port 68 is provided between the pair of leg parts 72b along the Y direction. The partition main body 72a does not overlap the drain port 68 on the connection part side along the X direction when viewed from the Z direction. Accordingly, water from the opening of the water-escape hole in the inlet 20 can easily reach the drain port 68. However, the partition main body 72a may overlap the entire drain port 68 when viewed from the Z direction.

The second partition 39 of the housing-side partition 37 has a part overlapping the drain port 68 on the connection part side along the X direction when viewed from the Z direction. That is, the second partition 39 of the housing-side partition 37 is provided at a part where the grommet-side partition 72 is not present when viewed from the Z direction. Accordingly, the second partition 39 of the housing-side partition 37 can suppress the entrance of dust and the like from the part where the grommet-side partition 72 is not present into the space where the wiring members 50 are disposed. The second partition 39 extends to a part where it overlaps the partition main body 72a along the X direction. The second partition 39 overlaps the entire drain port 68 along the X direction. The second partition 39 extends beyond the drain port 68 along the X direction.

The flange part 74 is provided around the leading end portion of the cylindrical connection part 67 along the X direction. The flange part 74 has an annular shape along the entire circumference of the side surface of the cylindrical connection part 67. For example, a worker can grab the flange part 74 when attaching the inlet 20 to the grommet 62, in particular, when shifting the connection port 66 in the X direction relative to the inlet 20. This improves the workability of attaching the grommet 62 to the inlet 20. However, the flange part 74 does not necessarily need to be provided. The flange part 74 may not have an annular shape along the entire circumference of the side surface of the cylindrical connection part 67, but may be partially formed on the side surface of the cylindrical connection part 67.

<Barrier Member>

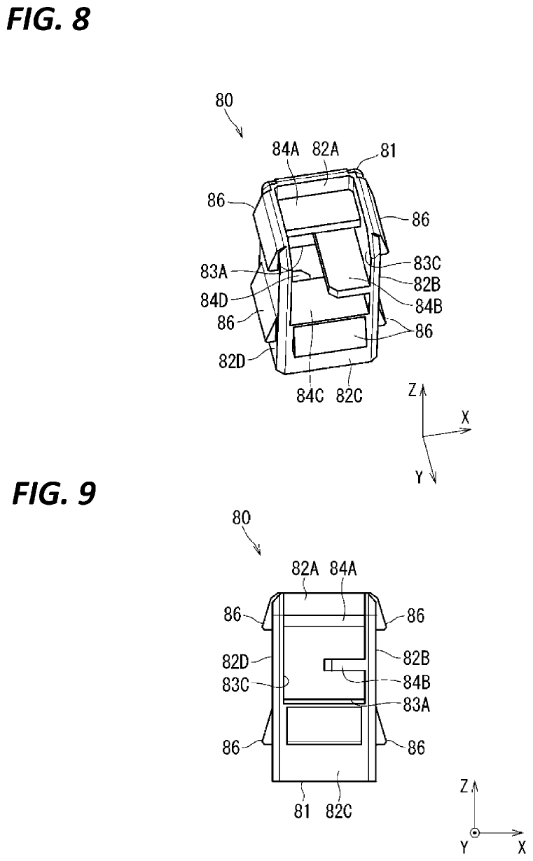

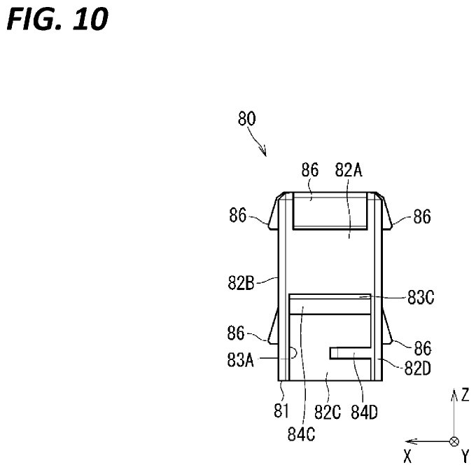

The barrier member 80 will be described with reference to FIGS. 8 to 10 in addition to FIGS. 1 to 7. FIG. 8 is a perspective view of the barrier member 80. FIG. 9 is a side view showing one side of the barrier member 80. FIG. 10 is a side view showing another side of the barrier member 80.

The barrier member 80 partially blocks the drain path in the tubular drain part 69. The internal drain path of the tubular drain part 69 is narrowed at the portion where the barrier member 80 is attached. The drain path is narrowed such that water in the grommet 62 can be drained to the outside of the grommet 62. In the drain path, the barrier member 80 secures a pathway necessary for draining water in the grommet 62 to the outside of the grommet 62, and narrows a pathway through which dust and the like outside of the grommet 62 may enter the grommet 62. As shown in FIG. 2, the drain path here is fully blocked by the barrier member 80 when observed from the Z direction.

The barrier member 80 has at least one side wall 82 and at least one partition 84. Here, the barrier member 80 also has at least one protrusion 86. In the present example, the barrier member 80 has four side walls 82, four partitions 84, and six protrusions 86. As a matter of course, the numbers of side walls 82, the partitions 84, and the protrusions 86 are not required to be these numbers, and can be set as appropriate.

The side walls 82 each have a plate shape extending along the inner surface of the tubular drain part 69. The four side walls 82 each have a rectangular shape (here, a square shape) when observed from the Z direction. That is, the four side walls 82 are connected together around an axis extending along the Z direction to form one frame body 81 that has a rectangular tubular shape. The outer surface of the frame body 81 has a shape similar to the shape of the inner surface of the tubular drain part 69. The inside of the frame body 81 constitutes the main drain path. No water passes between the outer surface of the frame body 81 and the inner surface of the tubular drain part 69, or if any passes, the amount of water is smaller than the amount of water that passes through the frame body 81.

The partitions 84 protrude from the inner surfaces of the side walls 82. The partitions 84 each have a plate shape that extends in a direction intersecting the Z direction. The thickness of the partitions 84 is the same as the thickness of the side walls 82. The partitions 84 partially block the internal space of the frame body 81. The partitions 84 respectively protrude from the four side walls 82. Each partition 84 is regarded as protruding from the side wall 82 to which one edge portion along a long side thereof is connected. Specifically, a partition 84A protrudes from a side wall 82A, a partition 84B protrudes from a side wall 82B, a partition 84C protrudes from a side wall 82C, and a partition 84D protrudes from a side wall 82D.

When observed from the Z direction, the size of each partition 84 is smaller than the size of the frame body 81. When observed from the Z direction, the size of each partition 84 may be the same as or larger than half the size of the frame body 81. When observed from the Z direction, the size of each partition 84 may be smaller than half the size of the frame body 81. Here, when observed from the Z direction, the size of each partition 84 is the same as half the size of the frame body 81.

When observed from the Z direction, each partition 84 has a shape in which a rectangle formed by the four side walls 82 is cut parallel to one side of the rectangle. Here, since the rectangle formed by the four side walls 82 is a square, the partitions 84 each have a rectangular shape.

In one rectangular partition 84, of a pair of edge portions along the long sides and a pair of edge portions along the short sides, one edge portion along a long side and the pair of edge portions along the short sides are connected to the side walls 82. Each partition 84 is regarded as protruding from the side wall 82 to which one edge portion along a long side thereof is connected.

Each partition 84 is connected to at least two side walls 84. The partition 84A is connected to three side walls 82A, 82B, and 82D. Similarly, the partition 84C is connected to three side walls 82B, 82C, and 82D. The partition 84B is connected to two side walls 82A and 82B. The partition 84D is connected to two side walls 82C and 82D. Each partition 84 may be connected to only one side wall 84.

The four partitions 84 are separated from one another in the Z direction. The region where the drain path is blocked is different at the four positions of the four partitions 84. Here, in particular, the four partitions 84 are provided in a spiral manner. That is, the order in which the partitions 84 are arranged from one side to the other side along the Z direction and the order in which the side walls 82 are arranged around the axis extending along the Z direction coincide with each other. Specifically, the side walls 82A to 82D are connected in this order around the axis along the Z direction. The partitions 84A to 84D corresponding to the side walls 82A to 82D are provided in this order from the positive side to the negative side along the Z direction. When observed from the Z direction, the partition 84A blocks half of the region in the frame body 81, on the negative side in the Y direction on the YZ plane that is shifted from the center of the frame body 81. When observed from the Z direction, the partition 84B blocks half of the region in the frame body 81, on the positive side in the X direction on the YZ plane that is shifted from the center of the frame body 81. When observed from the Z direction, the partition 84C blocks half of the region in the frame body 81, on the positive side in the Y direction on the YZ plane that is shifted from the center of the frame body 81. When observed from the Z direction, the partition 84D blocks half of the region in the frame body 81, on the negative side in the X direction on the YZ plane that is shifted from the center of the frame body 81.

Two surfaces of each partition 84, a first surface oriented toward the inside of the grommet 62 and a second surface oriented toward the outside of the grommet 62, are both surfaces orthogonal to the Z direction. The first surface of each partition 84 may be an inclined surface that is inclined toward the outside of the grommet 62 from the base end side (the side connected to the side walls 82) to the leading end side of the partition 84. Accordingly, water that has reached the first surface of a partition 84 is likely to be guided to the outside of the grommet 62 along the first surface, which is an inclined surface.

The protrusions 86 are provided on the outer surfaces of the side walls 82. The protrusions 86 are caught on the inner surface of the tubular drain part 69. Each protrusion 86 has a protruding dimension from the outer surface of the side wall 82 that increases with increasing proximity to the exit side of the tubular drain part 69 along the Z direction. The protrusions 86 are formed in the shape of a barb. Each protrusion 86 has a uniform lateral cross section shape (here, right triangular shape) that is continuous in the width direction. Each protrusion 86 is elongated in the width direction of the side wall 82. The length of each protrusion 86 along the width direction of the side wall 82 is larger than half the width of the side wall 82. The length of each protrusion 86 along the width direction of the side wall 82 is slightly smaller than the space between the pair of opposing side walls 82.

The protrusions 86 are separated between one end side and the other end side along the Z direction of the barrier member 80. On the one end side along the Z direction of the barrier member 80, three side walls 82 excluding the side wall 82C have the protrusions 86. On the other end side along the Z direction of the barrier member 80, three side walls 82 excluding the side wall 82A have the protrusions 86.

The barrier member 80 is press-fitted and attached to the inside of the tubular drain part 69. The outer surface of the barrier member 80 is larger than the inner surface of the tubular drain part 69 at least at the portions with the protrusions 86. The outer surface of the frame body 81 may be larger than the inner surface of the tubular drain part 69. In this case, the inner surface of the tubular drain part 69 comes into close contact with the outer surface of the frame body 81 so that the barrier member 80 is unlikely to be dislodged from the tubular drain part 69.

Among the four side walls 82, the pair of opposing side walls 82A and 82C have recessed parts 83. The recessed parts 83 are formed to separate metal molds in the vertical direction. The side walls 82A and 82C are examples of side walls with recessed parts. The barrier member 80 is formed in a shape in which no undercut is formed along the normal direction (Y direction) of the side walls 82A and 82C that are side walls with recessed parts. The barrier member 80 is formed in a shape in which an undercut is formed in the X direction and the Z direction. All of the surfaces of the barrier member 80 oriented toward the positive side in the Y direction appear in the side view as observed from the positive side in the Y direction (the side view shown in FIG. 9). All the surfaces of the barrier member 80 oriented toward the negative side in the Y direction appear in the side view as observed from the negative side in the Y direction (the side view shown in FIG. 10).

Specifically, in the side wall 82A, a recessed part 83A is provided on the negative side in the Z direction. The side wall 82A is provided in a region spanning from an intermediate part to the end portion on the positive side of the barrier member 80 along the Z direction. The side wall 82A is not provided in a region spanning from the intermediate part to the end portion on the negative side of the barrier member 80 along the Z direction. In the side wall 82C, a recessed part 83C is provided on the positive side in the Z direction. The side wall 82C is provided in the region spanning from the intermediate part to the end portion on the negative side of the barrier member 80 along the Z direction. The side wall 82C is not provided in the region spanning from the intermediate part to the end portion on the positive side of the barrier member 80 along the Z direction.

When observed from the Y direction, the side wall 82A and the side wall 82C do not overlap each other. When observed from the Y direction, the side wall 82A overlaps the recessed part 83C formed in the side wall 82C. Therefore, as shown in FIG. 9, when observed from the positive side in the Y direction, the side wall 82A is exposed through the recessed part 83C. When observed from the Y direction, the side wall 82C overlaps the recessed part 83A formed in the side wall 82A. Therefore, as shown in FIG. 10, when observed from the negative side in the Y direction, the side wall 82C is exposed through the recessed part 83A.

The side wall 82B is continuous from one end portion to the other end portion of the barrier member 80 along the Z direction. The sum of the length of the side wall 82A along the Z direction and the length of the side wall 82C along the Z direction is the same as or smaller than the length of the side wall 82B along the Z direction. Here, when observed from the Y direction, the side wall 82A and the side wall 82C are separated from each other in the Z direction. The sum of the length of the side wall 82A along the Z direction and the length of the side wall 82C along the Z direction is smaller than the length of the side wall 82B along the Z direction.

The barrier member 80 is fully housed in the tubular drain part 69. The length of the barrier member 80 along the Z direction is smaller than the length of the tubular drain part 69 along the Z direction. Accordingly, when the barrier member 80 is attached to the inside of the tubular drain part 69, the barrier member 80 is unlikely to protrude from the opening of the end portion of the tubular drain part 69. However, the length of the barrier member 80 along the Z direction may be the same as or larger than the length of the tubular drain part 69 along the Z direction. When the barrier member 80 is attached to the inside of the tubular drain part 69, the barrier member 80 may protrude from the opening of the end portion of the tubular drain part 69.

The barrier member 80 is an integrally molded article in which the four side walls 82, the four partitions 84, and the six protrusions 86 are integrally formed. The barrier member 80 is made of a resin, for example. The resin material may be a material that is harder than elastomer that is a material used for the grommet 62, for example. The resin material may be polypropylene (PP) or the like. The barrier member 80 may made of an aforementioned resin material and be integrally formed using a metal mold. For example, the barrier member 80 may be an injection-molded article that is molded using a metal mold.

The barrier member 80 is a member that is molded separately from the grommet 62. The fact that the barrier member 80 and the grommet 62 are separately molded members means that the barrier member 80 and the grommet 62 are molded using different metal molds, and are separated from each other in the molded state. After being separately molded, the barrier member 80 and the grommet 62 are attached to each other. Here, the barrier member 80 and the grommet 62 in the attached state are detachable from each other.

### Advantageous Effects

According to the grommet unit 60 and the wire harness 10 including the grommet unit 60 configured as described above, when the barrier member 80 partially blocks the drain path in the tubular drain part 69, the drain path can make dust and the like outside of the grommet 62 less likely to enter the grommet 62 while enabling the drainage of water from inside of the grommet 62. Since the barrier member 80 is a member that is molded separately from the grommet 62 and the inlet 20, it is not essential to change the structures of the grommet 62 and inlet 20. This makes it possible to suppress the entrance of dust and the like from the tubular drain part 69 while suppressing an increase in the complexity of structures of the grommet 62 and the inlet 20.

The barrier member 80 has at least one side wall 82 and at least one partition 84. The partition 84 can make it easier to block the drain path in the tubular drain part 69 so as to enable drainage of water from the inside and make dust and the like unlikely to enter from the outside. The presence of the side wall 82 makes it easy to keep the partition 84 in a posture appropriate for the tubular drain part 69.

Since the drain path is fully blocked by the barrier member 80 when observed from the Z direction, if dust and the like attempt to enter straight into the tubular drain part 69 along the X direction, the dust and the like collide with the barrier member 80. This makes the dust and the like less likely to reach the inside of the grommet 62 through the tubular drain part 69. Since the plurality of partitions 84 are separated from each other in the Z direction, it is easy to keep water in the grommet 62 in a state where it can be drained to outside of the grommet 62 through the partitions 84.

The barrier member 80 has four side walls 82 that form a rectangular shape when viewed from the Z direction, and the partitions 84 respectively protrude from the four side walls 82. Accordingly, the pathway for dust and the like to reach the inside of the grommet 62 through the tubular drain part 69 becomes more complex so that dust and the like are unlikely to reach the inside of the grommet 62 through the tubular drain part 69.

The four partitions 84 are provided in a spiral form. Accordingly, in order for dust and the like to pass through the barrier member 80, the dust and the like need to move in a spiral manner from one side to the other side along the Z direction. Thus dust and the like are unlikely to pass through the barrier member 80.

The barrier member 80 has the protrusions 86 that are provided on the outer surface of the side wall 82 and are caught on the inner surface of the tubular drain part 69. This makes the barrier member 80 unlikely to be dislodged from the tubular drain part 69.

The barrier member 80 has a shape in which no undercut is formed along the normal direction (Y direction) of the side walls 82A and 82C with recessed parts. Accordingly, when the barrier member 80 is injection-molded, the metal molds can be vertically removed along the Y direction, which suppresses an increase in the number of metal molds.

Inside the main body part 63, the grommet-side partition 72 is disposed between the space in which the wiring member 50 is disposed and the connection part between the tubular drain part 69 and the main body part 63. Accordingly, even if dust and the like enter the grommet 62 from the tubular drain part 69, the grommet-side partition 72 suppresses the dust and the like from reaching the space in which the wiring member 50 is disposed.

The main body part 63 has the pullout ports 70 that are open in the Y direction intersecting the X direction and the Z direction and through which the wiring member 50 is passed to the outside of the grommet 62. Accordingly, it is possible to decrease the height of a part of the grommet 62 attached to the connector 20 as compared to the case where the wiring member 50 extends from the grommet 62 in the X direction.

[Modifications]

It has been described above that the barrier member 80 has at least one side wall 82 and at least one partition 84. However, this is not an essential configuration. For example, the barrier member 80 may be shaped so as to have only one partition 84. That is, the barrier member 80 may have a flat plate shape and may be disposed inside the tubular drain part 69 such that the normal direction of the surface thereof intersects the Z direction.

It has been described above that the barrier member 80 has a plurality of partitions 84 and that the drain path is fully blocked by the barrier member 80 when observed from the Z direction. However, this is not an essential configuration. The drain path may not be fully blocked by the barrier member 80 when observed from the Z direction. For example, the protruding dimensions of the four partitions 84 may be smaller than half the distance between the pair of opposing side walls 82, and a gap may be formed between the four partitions 84 when observed from the Z direction.

It has been described above that the barrier member 80 has the four side walls 82 that are provided so as to form a rectangular shape when viewed from the Z direction, and the partitions 84 protrude from the four side walls 82. However, this is not an essential configuration. For example, in the barrier member 80, one, two, or three of the four side walls 82 may be omitted. Also, for example, if the barrier member 80 has four side walls 82, the four side walls 82 may include a side wall 82 without a protruding partition 84.

It has been described above that the four partitions 84 are provided in a spiral manner. However, this is not an essential configuration. The four partitions 84 may be provided in a form other than a spiral. For example, two partitions 84 protruding from the pair of opposing side walls 82 may be arranged in order along the Z direction.

It has been described above that the barrier member 80 includes the protrusions 86 that are provided on the outer surface of the side walls 82 and are caught on the inner surface of the tubular drain part 69. However, this is not an essential configuration. The protrusions 86 may be omitted from the barrier member 80. In this case, for example, when the barrier member 80 is being press-fitted into the tubular drain part 69, the inner surface of the tubular drain part 69 may strongly press against the outer surface of the side wall 82 so that the barrier member 80 is held in the tubular drain part 69.

It has been described above that the barrier member 80 is formed in a shape in which no undercut is formed along the normal direction of the side walls 82A and 82C that are side walls with recessed parts. However, this is not an essential configuration. The barrier member 80 may be formed in a shape in which an undercut is formed in all directions. The barrier member 80 may be formed through injection molding using three or more metal molds.

It has been described above that the main body part 63 has the grommet-side partition 72 that overlaps the tubular drain part 69 when viewed from the Z direction, and the grommet-side partition 72 is disposed inside the main body part 63 between the space in which the wiring member 50 is arranged and the connection part between the tubular drain part 69 and the main body part 63. However, this is not an essential configuration. For example, the grommet-side partition 72 may be omitted from the main body part 63.

It has been described above that the main body part 63 has the pullout ports 70 that are open in the Y direction that intersects the X direction and the Z direction and through which the wiring member 50 is passed to the outside of the grommet 62. However, this is not an essential configuration. For example, the pullout ports 70 may be open in the X direction opposite to the connection port 66.

[Supplementary Note]

In the above-described example, the barrier member 80 is attached to the grommet 62. Alternatively, the barrier member 80 may not be attached to the grommet 62 and a partition 84 may be directly provided on the tubular drain part 69 of the grommet 62. That is, the grommet may be integrally molded using a metal mold into a shape including the main body part 63, the tubular drain part 69, and the partitions 84.

The configurations in the embodiments and the modifications described above can be combined as appropriate provided no contradiction arises.

### LIST OF REFERENCE NUMERALS

10 Wire harness
20 Inlet (connector)
22 First member
23 First housing part
25 First cavity
26 First water-escape hole
28 Fixing part
32 Second member
33 Second housing part
35 Second cavity
36 Second water-escape hole
37 Housing-side partition
38 First partition
39 Second partition
40, 40A, 40B Terminal
50, 50A, 50B Wiring member
60 Grommet unit
62 Grommet
63 Main body part
64 First part
65 Second part
66 Connection port
67 Cylindrical connection part
68 Drain port
69 Tubular drain part
70 Pullout port
71, 71A, 71B Cylindrical pullout part
72 Grommet-side partition
72a Partition main body
72b Leg part
74 Flange part
80 Barrier member
81 Frame body
82, 82A, 82B, 82C, 82D Side wall
83, 83A, 83C Recessed part
84, 84A, 84B, 84C, 84D Partition
86 Protrusion
90 Inlet attachment part
92 Panel
94 Through hole

1. A grommet unit comprising:
a grommet that partially covers a connector and a wiring member mounted in a vehicle; and
a barrier member that is molded separately from the grommet,
wherein the grommet has a main body part that covers the connector and the wiring member and a tubular drain part that is continuous with the main body part and drains water inside the main body part,
the main body part has a connection port that is open in a first direction and into which a connection part of the connector is inserted,
the tubular drain part extends in a second direction that intersects the first direction, and
the barrier member is attached to the inside of the tubular drain part and partially blocks a drain path in the tubular drain part.

2. The grommet unit according to claim 1,
wherein the barrier member has at least one side wall that extends along an inner surface of the tubular drain part and at least one partition that protrudes from an inner surface of the side wall.

3. The grommet unit according to claim 2,
wherein the barrier member has a plurality of the partitions,
the plurality of partitions are separated from each other in the second direction,
a region where the drain path is blocked is different at a plurality of positions where the plurality of partitions are provided, and
the drain path is fully blocked by the barrier member when observed from the second direction.

4. The grommet unit according to claim 2,
wherein the barrier member has four side walls that are provided so as to form a rectangular shape when observed from the second direction, and
the partitions respectively protrude from the four side walls.

5. The grommet unit according to claim 4,
wherein the four partitions are provided in a spiral manner.

6. The grommet unit according to claim 2,
wherein the barrier member has a protrusion that is provided on an outer surface of the side wall and is caught on an inner surface of the tubular drain part.

7. The grommet unit according to claim 2,
wherein the barrier member is an injection-molded article that is molded using metal molds,
a side wall with a recessed part for separating metal molds in a vertical direction is provided as the side wall, and
the barrier member is formed in a shape in which no undercut is formed along a normal direction of the side wall with the recessed part.

8. The grommet unit according to claim 1,
wherein the main body part is provided with a grommet-side partition that overlaps the tubular drain part when viewed from the second direction, and
the grommet-side partition is disposed inside the main body part between a space in which the wiring member is disposed and a connection part between the tubular drain part and the main body part.

9. The grommet unit according to claim 1,
wherein the main body part has a pullout port that is open in a third direction intersecting the first direction and the second direction and through which the wiring member is passed to the outside of the grommet.

10. A wire harness comprising:
a connector;
a wiring member that extends from the connector; and
the grommet unit according to claim 1,
wherein the grommet partially covers the connector and the wiring member.
